(19) United States
(12) Patent Application Publication
(10) Pub. No.: US 2010/0054165 A1
(43) Pub. Date: Mar. 4, 2010

(54) DATA TRASNMITTING AND RECEIVING METHOD AND COMMUNICATION SYSTEM THEREOF

(75) Inventors: Tae-Yun Chung, Gangwon-do (KR); Lae-Jeong Park, Gangwon-do (KR); Yong-Soon Park, Gangwon-do (KR)

Correspondence Address: THE NATH LAW GROUP, 112 South West Street, Alexandria, VA, 22314, US

(73) Assignee: KANGNUNG-WONJU NATIONAL UNIVERSITY INDUSTRIAL COMP CORPORATION GROUP, Gangneung -shi, Gangwon-do (KR)

(21) Appl. No.: 12/448,855

(22) PCT Filed: Jan. 9, 2008
(86) PCT No.: PCT/KR2008/000134

§ 371 Date: Jul. 10, 2009

(30) Foreign Application Priority Data
Jan. 15, 2007 (KR) 10-2007-0004098

(51) Int. Cl. H04L 12/56; H04L 5/16

(52) U.S. Cl. 370/296; 370/400

(57) ABSTRACT

A data transmitting and receiving method and a communication system using the method are provided. A transmitting node generates a plurality of data packets by dividing a large-sized data and transmits the data packets to a receiving node at one time, and after that, re-transmits only the non-received data packet(s) which is not received by the receiving node. Accordingly, the number of response packets which the receiving node is to transmit can be reduced, so that it is possible to increase transmission rate.

### TECHNICAL FIELD

The present invention relates to a half-duplex communication system, and more particularly, to a method of transmitting and receiving a large-sized data in a half-duplex communication scheme and a communication system using the method.

### BACKGROUND ART

A half-duplex communication scheme is communication scheme in which data transmission and reception is performed in on direction but not in two directions. In such a half-duplex communication scheme, when a transmitting node transmits packets to a receiving node, the receiving node receives the packets and, after that, transmits response packets according the received packets so as to notify that reception of the packets is normally performed. Since the response packet needs to be transmitted every time of transmission of packets, the number of transmitted and received packets for transmission of a large-sized data is increased, so that data transmission rate may be decreased. Therefore, a technique for increasing the transmission rate by reducing the number of response packets which the receiving node is to transmit needs to be developed.

In addition, in a sensor network system using such a half-duplex communication scheme, since each node generally has a very small storage capacity, a large-sized data is not easy to transmit and receive. Therefore, a technique for transmitting and receiving the large-sized data such as an image data by using the sensor nodes having a very small storage capacity needs to be developed.

### DISCLOSURE

### Technical Problem

In order to solve the aforementioned problems, the present invention provides a data transmitting and receiving method in a half-duplex communication system capable of reducing the number of response packets which a receiving node is to transmit and increasing transmission rate by allowing a transmitting node to transmit data packets generated by dividing a large-sized data to the receiving node and, after that, to re-transmit only a non-received packet(s) to the receiving node and a communication system using the method.

in addition, the present invention also provides a data transmitting and receiving method capable of transmitting and receiving a large-sized data through a sensor network system by connecting sensor nodes of the senor network system to an external storage medium, allowing the senor nodes to receives packets and store the received packets in the external storage medium and a communication system using the method.

### Technical Solution

According to an aspect of the present invention, there is provided a data transmitting and receiving method in a communication system having a transmitting node and a receiving node, comprising steps of: when the transmitting node transmitting information of the number of data packets to the receiving node, the receiving node receiving the information of the number of data packets and generating index information including indices of the data packets and storing the index information; the transmitting node transmitting the data packets to the receiving node; every time when the data packet is received from the transmitting node, the receiving node marking the index of the data packet in the index information and strong the received data packet; if a final data packet is received from the transmitting node or if the transmission of the data packet from the transmitting is ended, the receiving node checking a non-received data packet(s) according to existence of the marking of the index information; if the non-received data packet(s) exists, the receiving node transmitting information of the checked non-received data packet(s) to the transmitting node, and if any non-received data packet does not exist, the receiving node transmitting information of reception completion to the transmitting node; and if the information of the non-received data packet(s) is received from the receiving node, the transmitting node re-transmitting the non-received data packet(s) to the receiving node, and if the information of the transmission completion is received, the reception of data packet being completed.

According to the present invention, in a half-duplex communication system, a transmitting node transmits data packets generated by dividing a large-sized data to a receiving node at one time, and after that, re-transmits only non-received data packet(s) which is not received by the receiving node, so that the number of response packets which the receiving node is to transmit can be reduced. Accordingly, it is possible to increase transmission rate. In addition, according to the present invention, in a sensor network system, senor nodes are connected to an external storage medium, and senor nodes are allowed to receive packets and store the packets in the external storage medium. Accordingly, it is possible for the sensor network system to transmit and receive the large-sized data.

### Advantageous Effects

According to the present invention, in a half-duplex communication system, a transmitting node transmits data packets generated by dividing a large-sized data to a receiving node at one time, and after that, re-transmits only non-received data packet(s) which is not received by the receiving node, so that the number of response packets which the receiving node is to transmit can be reduced. Accordingly, it is possible to increase transmission rate.

In addition, according to the present invention, in a sensor network system, senor nodes are connected to an external storage medium, and senor nodes are allowed to receive packets and store the packets in the external storage medium. Accordingly, it is possible for the sensor network system to transmit and receive the large-sized data.

### DESCRIPTION OF DRAWINGS

FIG. 1 is a view illustrating a configuration of a communication system according to a preferred embodiment of the present invention.

FIG. 2 is a view illustrating a data structure of an external storage medium according to a preferred embodiment of the present invention.

FIG. 3 is a flowchart of a data transmitting/receiving method according to a preferred embodiment of the present invention.

### BEST MODE

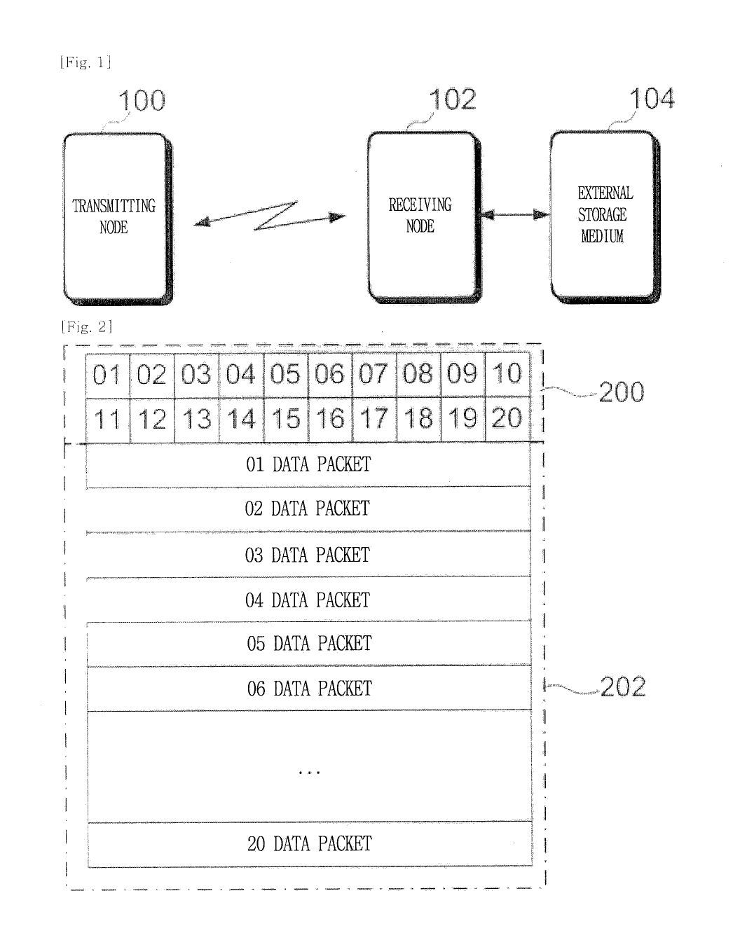

A schematic configuration of a communication system according to a preferred embodiment of the present invention will be described with reference to FIG. 1. The communication system is a sensor network system including a larger number of senor nodes. Hereinafter, for the convenience of description, a sensor node of transmitting a data is referred to as a transmitting node, and a sensor node of receiving a data is referred to as a receiving node. The communication system includes transmitting nodes 100 and receiving nodes 102 connected to an external storage medium 104.

The transmitting node 100 loads a large-sized data from an external storage apparatus (not shown) or the like and divides the large-sized data into a plurality of data packets. The transmitting node transmits information of the number of data packets to the receiving node 102, and after that, transmits the data packets. If information on the non-received data packet(s) exists in a response packet received from the receiving node 102, the transmitting node re-transmits only the corresponding data packets. If information of reception completion exists in the response packet, the transmitting node completes the transmission of the large-sized data. As an example of the large-sized data, there is an image data.

When the information of the number of data packets divided from the large-sized data is received from the transmitting node 100, the receiving node 102 configures index information including indices of the data packets according to information of the number of data packets and stores the index information in the external storage medium 104. Next, every time when a data packet is received from the transmitting node 100, the receiving node marks the index of the data packet and stores the received data packet in the external storage medium 104.

When the final data packet is received from the transmitting node or when the transmission and reception of the data packets with respect to the transmitting node are ended, the receiving node 102 checks a non-received data packet(s) according to existence of the marking of the index information. If the non-received data packet(s) exists, the receiving node transmits to the transmitting node 100 a response packet including identification information of the non-received packet data. If any non-received data packet does not exist, the receiving node transmits to the transmitting node 100 a response packet representing reception completion.

In a case where the non-received data packet(s) is re-received from the transmitting node 100, the receiving node marks the index of the re-received data packet(s) and stores the re-received data packet(s) in the external storage medium 104.

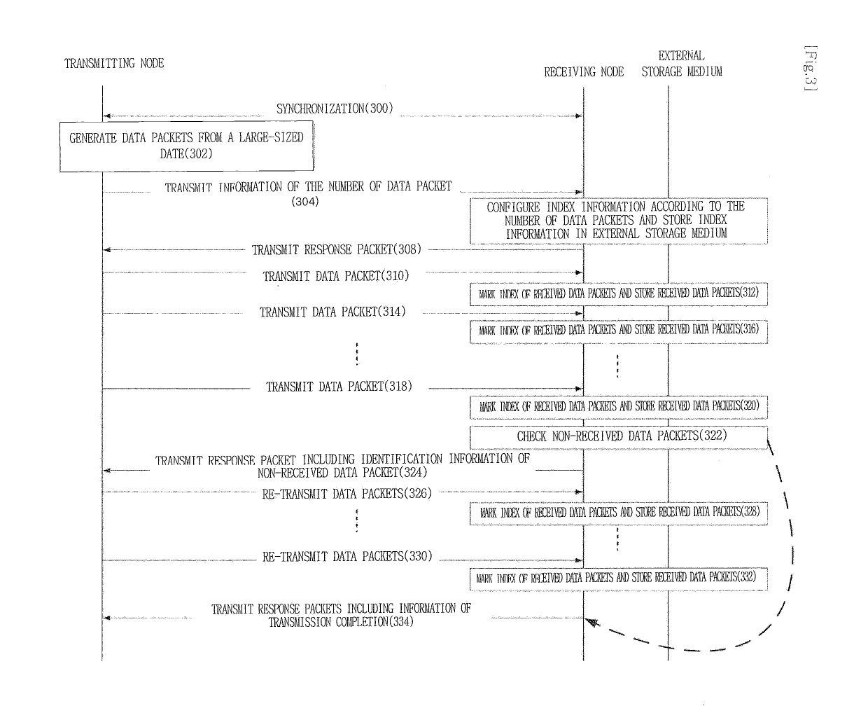

As shown in FIG. 2, the external storage medium 104 stores the index information 200 including the indices of data packets configured based on the information of the number of data packets transmitted by the transmitting node 100 and the received data packets 202.

Hereinafter, operations of the communication system having the aforementioned configuration will be described in detail with reference to FIG. 3.

When data transmission to the receiving node 102 is requested, the transmitting node 100 performs a synchronization procedure for communication with the receiving node 102 (Step 300).

Next, the transmitting node 100 loads a large-sized data from an external storable apparatus or the like and generates a plurality of data packets (Step 302). The transmitting node 100 transmits to the receiving node 102 information of the number of data packets (Step 304). When receiving the information of the number of data packets, the receiving node 102 configures index information of the including indices of the data packets according to the number of data packets and stores the index information in the external storage medium 104 (Step 306). Next, the receiving node 102 transmits to the transmitting node 100 a response packet corresponding to reception of the information of the number of data packets (Step 308). In this manner, the transmitting node 100 transmits the information of the number of data packets to the receiving node 102 before transmission of the large-sized data. Therefore, the receiving node 102 can configure the index information based on the information the number of data packet in advance.

As described above, when receiving the response packet corresponding to the transmission of the information of the number of data packets, the transmitting node 100 transmits the data packets generated by dividing the large-sized data to the receiving node 102 (Steps 310, 314, and 318). Every time when a data packet is received from the transmitting node 100, the receiving node 102 marks the index of the received data packet and stores the received data packet in the external storage medium (Steps 312, 316, and 320). More specifically, the transmitting node 100 inserts predetermined identification information representing the final data packet to the final data packet of the data packets and transmits the data packets. If the data packet with the predetermined identification information inserted therein exists among the received data packets, the receiving node 102 determines that the data packet is the final data packet. In addition, if any data packet is not received from the transmitting node 100 for a predetermined time interval, the receiving node 102 determines that the transmission and reception of data packets are ended.

As described above, if the transmission and reception of the final data packet are completed or if the transmission and reception of data packets are ended, the receiving node 102 checks a non-received data packet(s) according to existence of the mark of the index information (Step 322).

If the non-received data packet(s) exists, the receiving node 102 generates a response packet including identification information of the non-received data packet(s) and transmits the response packet to the transmitting node 100 (Step 324). When receiving the response packet, the transmitting node 100 re-transmits to the receiving node 102 only the data packet corresponding to the identification information of the non-received data packet(s) (Steps 326 and 330). Every time when the data packet is received from the transmitting node 100, the receiving node 102 stores the received data packet in the external storage medium 104 (Step 332).

After the re-transmission and re-reception of data packets, the receiving node 102 checks the existence of a non-received data packet(s). According to a result of the checking, the transmission of the response packet including the identification information of the non-received data packet(s) and the re-transmission and re-reception of data packet are repeatedly performed.

When the receiving node 102 receives all the data packets transmitted by the transmitting node 100, the receiving node 102 generates a response packet including information of transmission completion and transmits the response packet to the transmitting node 100 (Step 334). When the response packet is received, the transmission and reception of data packets between the transmitting node 100 and the receiving node 102 are completed.

While the present invention has been particularly shown and described with reference to exemplary embodiments thereof, it will be understood by those skilled in the art that various changes in form and detail may be made therein without departing from the spirit and scope of the present invention as defined by the appended claims.

### INDUSTRIAL APPLICABILITY

A technique according to the present invention can be widely used for a wireless sensor network configured with a plurality of sensor nodes.

1. A data transmitting and receiving method in a communication system having a transmitting node and a receiving node, comprising steps of:
when the transmitting node transmitting information of the number of data packets to the receiving node, the receiving node receiving the information of the number of data packets and generating index information including indices of the data packets and storing the index information;
the transmitting node transmitting the data packets to the receiving node;
every time when the data packet is received from the transmitting node, the receiving node marking the index of the data packet in the index information and storing the received data packet;
if a final data packet is received from the transmitting node or if the transmission of the data packet from the transmitting node is ended, the receiving node checking a non-received data packet(s) according to existence of the marking of the index information;
if the non-received data packet(s) exists, the receiving node transmitting information of the checked non-received data packet(s) to the transmitting node, and if any non-received data packet does not exist, the receiving node transmitting information of reception completion to the transmitting node; and
if the information of the non-received data packet(s) is received from the receiving node, the transmitting node re-transmitting the non-received data packet(s) to the receiving node, and if the information of the transmission completion is received, the reception of data packet being completed,
wherein the receiving node stores the index information and the data packets in an external storage medium,
wherein the data packets are generated by dividing a large-sized data read out from an external storage medium.

2. (canceled)

3. (canceled)

4. A communication system comprising:
a transmitting node which transmits a plurality of data packets to a receiving node after transmitting information of the number of data packets to the receiving node and re-transmits non-received data packet(s) when receiving information of the non-received data packet(s); and
the receiving node which, when the information of the number of data packets is received from the transmitting node, generates and stores index information including indices of the data packets; every time when the data packet is received, marks the index of the received data packet in the index information; if a final data packet is received from the transmitting node or if reception of data packets is ended, checks a non-received data packet(s) according to existence of the marking of the index information; transmits to the transmitting node a response packet including information of the checked non-received data packet(s); and if any non-received data packet does not exist, transmits information of reception completion,
wherein the index information and the data packets are stored in an external storage medium,
wherein the data packets are generated by dividing a large-sized data read out from an external storage medium.

5. (canceled)

6. (canceled)
